(19) United States
(12) Patent Application Publication
(10) Pub. No.: US 2023/0276817 A1
(43) Pub. Date: Sep. 7, 2023

(54) PREPARATION AND METHOD FOR IMPROVING RiNG ROT RESISTANCE OF APPLE FRUITS

(71) Applicant: Shandong Institute of Pomology, Tai'an (CN)

(72) Inventors: Xiaowen He, Tai'an (CN); Hui Meng, Tai'an (CN); Chen Wang, Tai'an (CN); Ping He, Tai'an (CN); Haibo Wang, Tai'an (CN); Nan Wang, Tai'an (CN); Yuansheng Chang, Tai'an (CN); Sen Wang, Tai'an (CN); Linguang Li, Tai'an (CN)

(73) Assignee: Shandong Institute of Pomology, Tai'an (CN)

(21) Appl. No.: 18/091,417

(22) Filed: Dec. 30, 2022

Related U.S. Application Data
(63) Continuation of application No. PCT/CN2022/070679, filed on Jan. 7, 2022.

(51) Int. Cl. A23B 7/154; A01N 31/02; A01P 1/00; A23L 3/349

(52) U.S. Cl. CPC A23B 7/154; A01N 31/02; A01P 1/00; A23L 3/349

(57) ABSTRACT

The present invention discloses a preparation and a method for improving ring rot resistance of apple fruits and belongs to the technical field of plant disease resistance. Resistance of apple fruits to ring rot may be significantly improved by soaking the fruits with a sorbitol solution. Moreover, the sorbitol solution is effective to multiple varieties; the barrier in control of ring rot through chemical pesticides and the like may be overcome; and pollution of the pesticides and the like to the ecological environment is greatly decreased, thereby decreasing losses caused by occurrence of apple ring rot in a maturation period or a storage period.

### CROSS REFERENCE TO RELATED APPLICATION

This patent application is a continuation application of PCT/CN2022/070679, filed on Jan. 7, 2022, the disclosure of which is incorporated by reference herein in its entirety as part of the present application.

### TECHNICAL FIELD

The present invention belongs to the technical field of disease resistance of plants, and particularly relates to a preparation and a method for improving ring rot resistance of mature apple fruits.

### BACKGROUND

Apple ring rot is one of three major diseases in main producing areas of apples in China and seriously restricts sustainable development of the apple industry. The apple ring rot is caused by a pathogenic fungus, that is, Botryosphaeria dothidea, and mainly damages branches and fruits of apples. When the branches are damaged, reddish brown spots are formed on lenticels; the center protrudes like a tumor, the edge cracks; the phloem is seriously damaged; transport of nutrients is affected; and the tree body dies in serious cases. The fruits are mainly damaged in a maturation period and a storage period; alternate dark and light brown concentric ring rots are formed on the surfaces of the fruits and rapidly spread around; and thus, edibleness of the fruits is lost. At present, with the large-scale popularization of varieties that have excellent quality and are susceptible to the apple ring rot, such as Red delicious, Fuji and Gala, the occurrence frequency and incidence degree of the apple ring rot are significantly increased. In hot and humid central China (such as Henan and Shanxi provinces) and the eastern rim of Bohai Bay (such as Liaoning. Shandong and Hebei provinces), a loss rate of orchards with the apple ring rot is up to about 50%, thereby seriously affecting apple production. Meanwhile, an incubation period of the Botrysphaeria dothidea is longer; and serious yield loss will be caused due to occurrence in the storage period.

At present, the apple ring rot is mainly controlled by a method for spraying pesticides in apple production. Lots of manpower and material resources are consumed; serious environmental pollution is caused; the ecological balance is affected; and drug resistance of strains and other problems are brought. Therefore, development of a plant-derived antimicrobic agent has important practical significance and application value for effectively controlling the apple ring rot. In Rosaceac plants, sorbitol is a major carbohydrate for photosynthate transport. When formed in chloroplasts of apple leaves, assimilation products are mainly transported to other parts in the form of the sorbitol. Studies have shown that, the sorbitol plays a crucial role in stress resistance of plants. In addition, the sorbitol in the apple leaves has a higher content, and often accounts for 80% of the whole soluble compound. However, the sorbitol has a very low content in the apple fruits, and only accounts for 3-8%. Therefore, the current urgent task of controlling the apple ring rot and other fungal diseases is to research applications of the sorbitol and other intrinsic metabolites of plants in control of the ring rot of the apple fruits, which is also the only route of realizing green, environment-friendly and efficient development of the apple industry in the long run.

The present invention provides a method for conducting exogenous sorbitol treatment on mature apple fruits to improve the resistance of the fruits to the apple ring rot. In the present invention, by respectively taking widely-cultivated apple varieties, such as “Red delicious”, “Fuji”, “Gala” and “Golden delicious”, as examples, the effects of application of the technical method in improvement of apple fruit resistance to the apple ring rot are described.

The technical method has the characteristics of being efficient, feasible, green and environment-friendly, may improve the resistance of apples to the ring rot, contributes to decreasing economic losses caused by incidence of the fruits in the maturation period or the storage period, and lays a foundation for screening and identification of disease-resistant materials of the apple and intensive study of disease-resistant action mechanisms of the apple.

Therefore, how to provide a preparation and a method for improving ring rot resistance of mature apple fruits is a problem that urgently needs to be solved in the art.

### SUMMARY

The present invention discloses a preparation and a method for improving ring rot resistance of mature apple fruits.

To achieve the above purpose, technical solutions of the present invention are as follows:

The preparation for improving ring rot resistance of mature apple fruits includes sorbitol.

The apple fruits are mature apple fruits.

Preferably, a concentration of the sorbitol is 100-300 mM.

Preferably, the concentration of the sorbitol is 200 mM.

The present invention further discloses an application of the above preparation in preparing a ring rot resistant preparation for apple fruits.

The present invention further discloses an application of the above preparation in preparing a preparation for improving apple preservation time.

The present invention further discloses an application of the above preparation in preparing a preparation for improving apple food preservation time.

According to the above preparation, the apples are one or more of “Red delicious”, “Fuji”, “Gala” and “Golden delicious”.

A method for improving ring rot resistance of mature apple fruits is disclosed, and the apples are soaked with a sorbitol solution.

Preferably, a concentration of the sorbitol is 100-300 mM.

Preferably, the concentration of the sorbitol is 200 mM.

According to the method for improving ring rot resistance of mature apple fruits, the soaking time is 3 h.

To sum up, the present invention discloses the method for improving ring rot resistance of the apple fruits. Resistance of the fruits to ring rot may be significantly improved by soaking the apple fruits with the sorbitol solution. Moreover, the sorbitol solution is effective to multiple varieties; the barrier in control of ring rot through chemical pesticides and the like may be overcome; and pollution of the pesticides and the like to the ecological environment is greatly decreased, thereby decreasing losses caused by occurrence of the apple ring rot in the maturation period or the storage period

### BRIEF DESCRIPTION OF DRAWINGS

FIG. 1 shows a phenotype of inoculated Botryosphaeria dothidea after treatment of “Red delicious” apples with sorbitol of different concentrations in the present invention;

FIG. 2 shows a phenotype of inoculated Botryosphaeria dothidea after treatment of “Fuji” apples with sorbitol of different concentrations in the present invention;

FIG. 3 shows a phenotype of inoculated Botryosphaeria dothidea after treatment of “Gala” apples with sorbitol of different concentrations in the present invention;

FIG. 4 shows a phenotype of inoculated Botryosphaeria dothidea after treatment of “Golden delicious” apples with sorbitol of different concentrations in the present invention:

FIG. 5A shows statistics of incidence degrees of ring rot after treatment of “Red delicious” fruits with sorbitol of different concentrations in the present invention;

FIG. 5B shows statistics of incidence degrees of ring rot after treatment of “Fuji” fruits with sorbitol of different concentrations in the present invention;

FIG. 5C shows statistics of incidence degrees of ring rot after treatment of “Gala” fruits with sorbitol of different concentrations in the present invention; and

FIG. 5D shows statistics of incidence degrees of ring rot after treatment of “Golden delicious” fruits with sorbitol of different concentrations in the present invention.

### DETAILED DESCRIPTION OF THE EMBODIMENTS

The technical solutions in embodiments of the present invention will be clearly and fully described below. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

### Embodiment 1

The present embodiment provides a culture method of Botryosphaeria dothidea and a preparation method of a sorbitol solution.

S11: Culture of Botryosphaeria dothidea

A fungus block of Botrvosphaeria dothidea was inoculated in a potato dextrose agar (PDA) medium by a puncher having a diameter of 5 mm, and inverted and cultured in the dark at 28° C. for 10 days.

S12: Preparation of the Sorbitol Solution

In the present invention, 4 concentration gradients of the sorbitol solution were set as follows: 100 mM, 150 mM, 200 mM and 300 mM. A specific preparation method was as follows:

Sorbitol solution of 100 mM: sterilized deionized water was added into 36.436 g of D-Sorbitol until the volume was fixed to 2000 mL; and the D-Sorbitol was fully dissolved for later use.

Sorbitol solution of 150 mM: sterilized deionized water was added into 54.654 g of D-Sorbitol until the volume was fixed to 2000 mL; and the D-Sorbitol was fully dissolved for later use.

Sorbitol solution of 200 mM: sterilized deionized water was added into 72.872 g of D-Sorbitol until the volume was fixed to 2000 mL: and the D-Sorbitol was fully dissolved for later use.

Sorbitol solution of 300 mM: sterilized deionized water was added into 109.308 g of D-Sorbitol until the volume was fixed to 2000 mL; and the D-Sorbitol was fully dissolved for later use.

### Embodiment 2

To verify whether external application of sorbitol can improve resistance of apple fruits to ring rot, an inoculation experiment of “Red delicious” apple fruits was provided in embodiment 2 of the present application.

S21: An in-vitro inoculation method was adopted for identifying disease resistance of the “Red delicious” apple fruits; and 6 treatments were set as follows:

Single pathogenic fungus inoculation treatment;

Pathogenic fungus inoculation treatment of soaking in deionized water;

Pathogenic fungus inoculation treatment of soaking in sorbitol solution of 100 mM:

Pathogenic fungus inoculation treatment of soaking in sorbitol solution of 150 mM;
Pathogenic fungus inoculation treatment of soaking in sorbitol solution of 200 mM:

Pathogenic fungus inoculation treatment of soaking in sorbitol solution of 300 mM.

S22: Surfaces of mature “Red delicious” fruits (within 140 days after flowering) were disinfected with 0.1% of sodium hypochlorite; and the fruits were fully washed with sterilized deionized water, aired and stood at 25° C. for 12 h for later use.

S23: The “Red delicious” fruits of the same size were selected and respectively soaked in the sterilized deionized water, the sorbitol solution of 100 mM, the sorbitol solution of 150 mM, the sorbitol solution of 200 mM and the sorbitol solution of 300 mM; and 10 fruits were treated in each treatment. The apples were taken out within 3 h after treatment; surface liquid was wiped up; middle parts of the surfaces of the apple fruits were punctured by sterilized toothpicks at a depth of 5 mm: 0.02 g of Botryosphaeria. dothidea hyphae having vigorous and consistent growth within 10 days was added into the punctured parts; and the single pathogenic fungus inoculation treatment was taken as control. After inoculation, the “Red delicious” fruits were cultured in a thermostatic incubator at 28° C. in the dark. A disease spot diameter served as a measurement standard of the incidence degree of the apple fruits; diameters of 5 points of each disease spot were measured; and the mean value was taken as the result. Since 3 d after treatment, disease spot diameters of the apple fruits in different treatments were photographed and recorded every day; and the diameters were continuously recorded for 4 d. A significance level of disease spot size differences among the treatment groups was calculated according to analysis of variance.

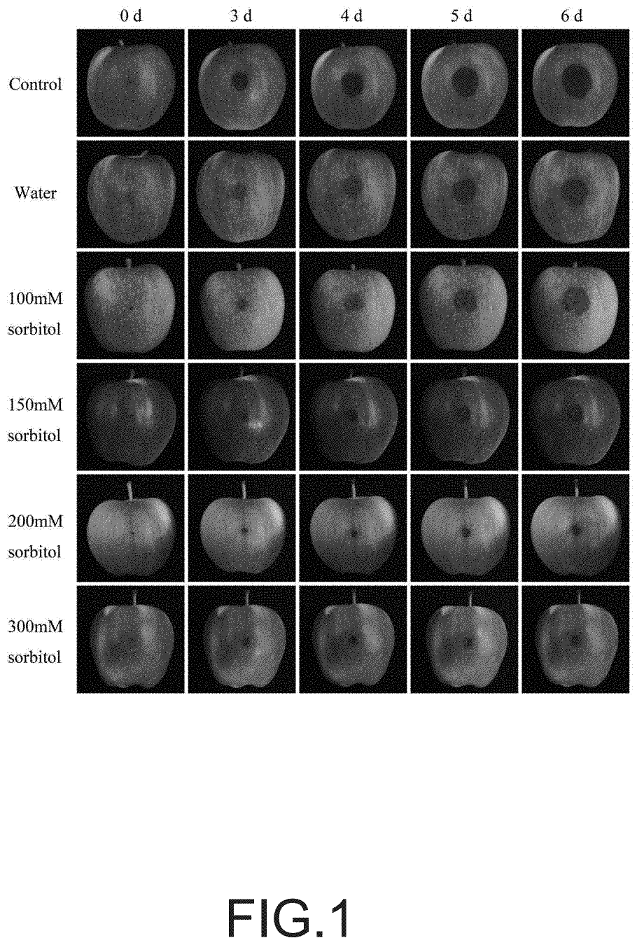

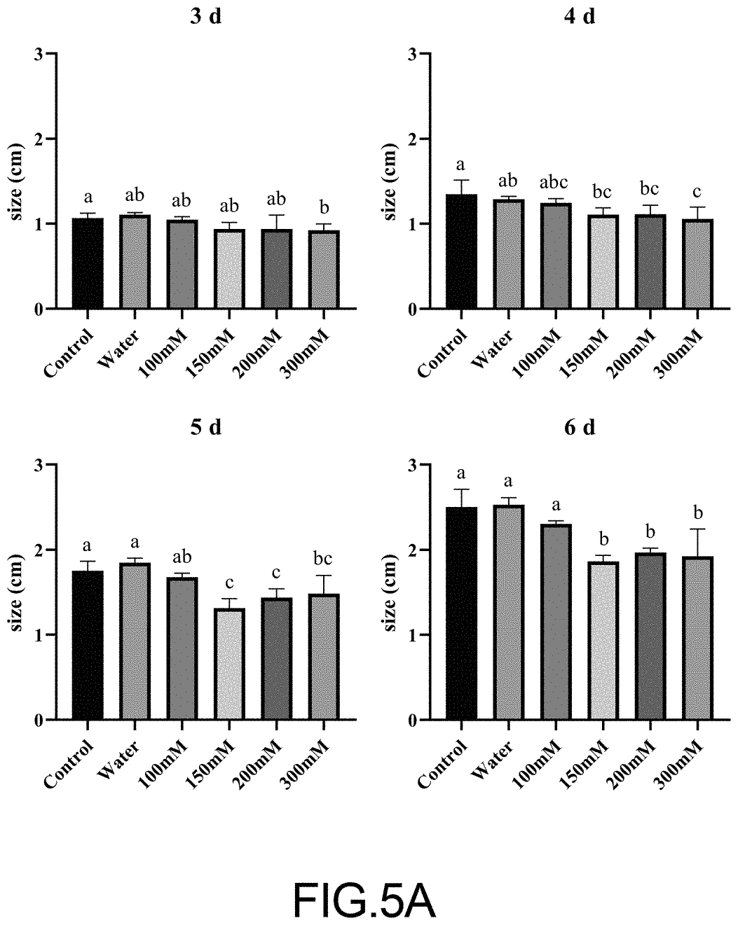

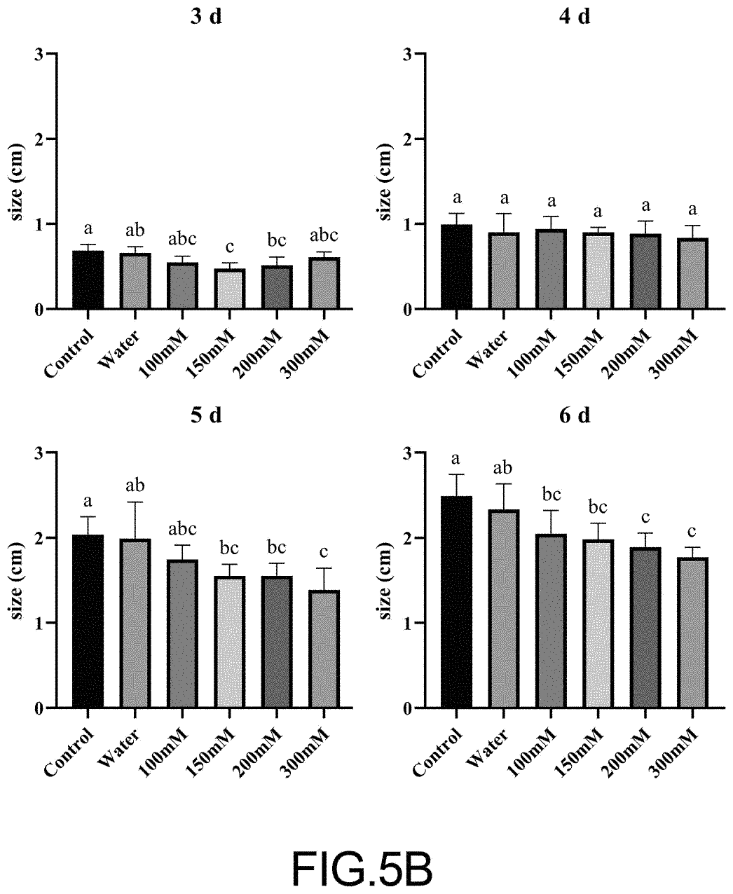

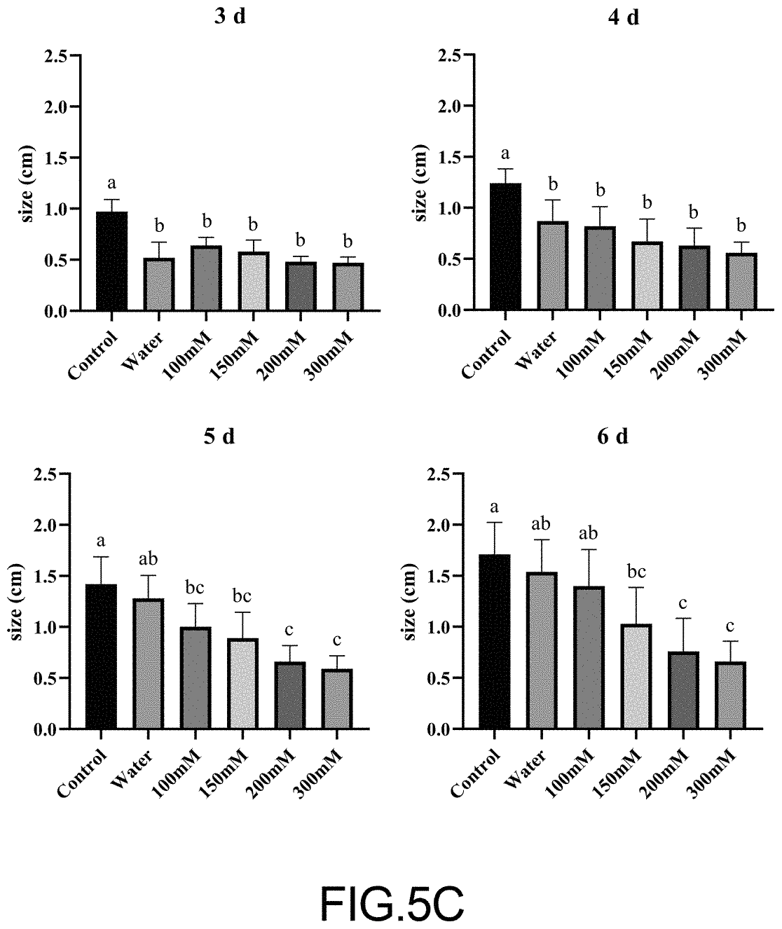

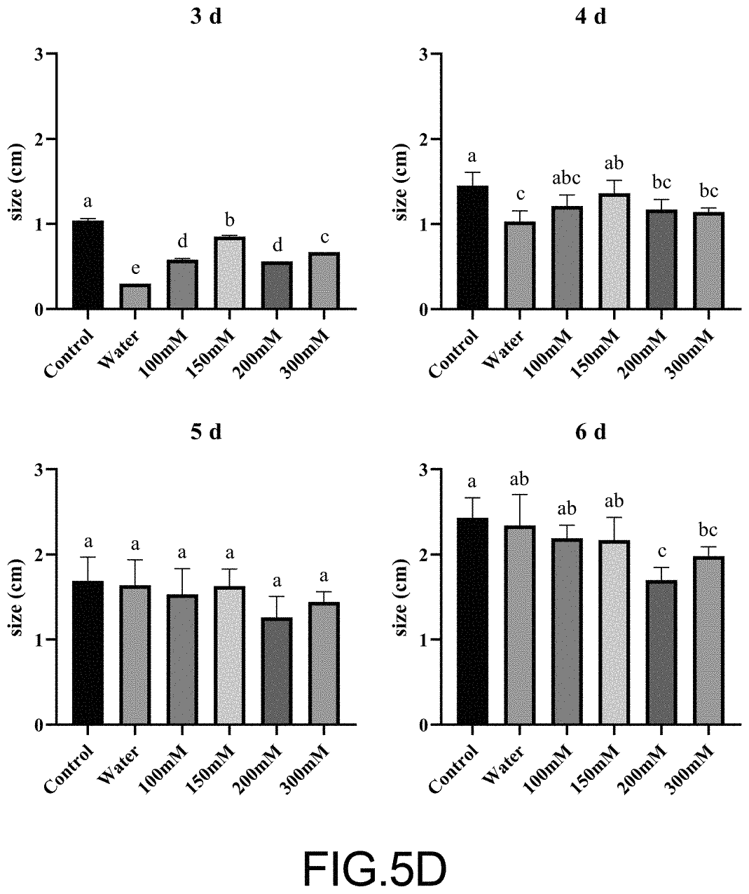

Within 3 d, 4 d, 5 d and 6 d after inoculation, the incidence conditions of ring rot of the “Red delicious” fruits were shown as FIG. 1; and statistical results of the disease spot diameters were shown as FIG. 5A. With extension of the inoculation time, compared with the control, an increase rate of the disease spot diameters of the “Red delicious” fruits treated with the sorbitol solution was significantly decreased; within 6 d after inoculation, the disease spot diameter of the “Red delicious” fruits in the single pathogenic fungus inoculation treatment was 1.71 cm; with the increase of the concentration of the sorbitol solution, the disease spot diameter of the “Red delicious” fruits was significantly decreased; and the disease spot diameter of the “Red delicious” fruits treated with the sorbitol solution of 200 mM was 0.76 cm, and had no significant difference from the disease spot diameter of the “Red delicious” fruits treated with the sorbitol solution of 300 mM. The above descriptions showed that the sorbitol treatment significantly inhibited the enlargement of the ring rot disease spots of the “Red delicious” fruits; and an optimum treatment concentration was 200 mM.

### Embodiment 3

To verify whether external application of sorbitol can improve resistance of apple fruits to ring rot, an inoculation experiment of “Fuji” apple fruits was provided in embodiment 3 of the present application.

S31: An in-vitro inoculation method was adopted for identifying disease resistance of the “Fuji” apple fruits; and 6 treatments were set as follows:

Single pathogenic fungus inoculation treatment;

Pathogenic fungus inoculation treatment of soaking in deionized water;

Pathogenic fungus inoculation treatment of soaking in sorbitol solution of 100 mM;

Pathogenic fungus inoculation treatment of soaking in sorbitol solution of 150 mM;

Pathogenic fungus inoculation treatment of soaking in sorbitol solution of 200 mM:

Pathogenic fungus inoculation treatment of soaking in sorbitol solution of 300 mM.

S32: Surfaces of mature “Fuji” fruits (within 180 days after flowering) were disinfected with 0.1% of sodium hypochlorite; and the fruits were fully washed with sterilized deionized water, aired and stood at 25° C. for 12 h for later use.

S33: The “Fuji” fruits of the same size were selected and respectively soaked in the sterilized deionized water, the sorbitol solution of 100 mM, the sorbitol solution of 150 mM, the sorbitol solution of 200 mM and the sorbitol solution of 300 mM; and 10 fruits were treated in each treatment. The apples were taken out within 3 h after treatment; surface liquid was wiped up; middle parts of the surfaces of the apple fruits were punctured by sterilized toothpicks at a depth of 5 mm; 0.02 g of Botryosphaeria dothidea hyphae having vigorous and consistent growth within 10 days was added into the punctured parts; and the single pathogenic fungus inoculation treatment was taken as control. After inoculation, the “Fuji” fruits were cultured in a thermostatic incubator at 28° C. in the dark. A disease spot diameter served as a measurement standard of the incidence degree of the apple fruits; diameters of 5 points of each disease spot were measured; and the mean value was taken as the result. Since 3 d after treatment, disease spot diameters of the apple fruits in different treatments were photographed and recorded every day; and the diameters were continuously recorded for 4 d. A significance level of disease spot size differences among the treatment groups was calculated according to analysis of variance.

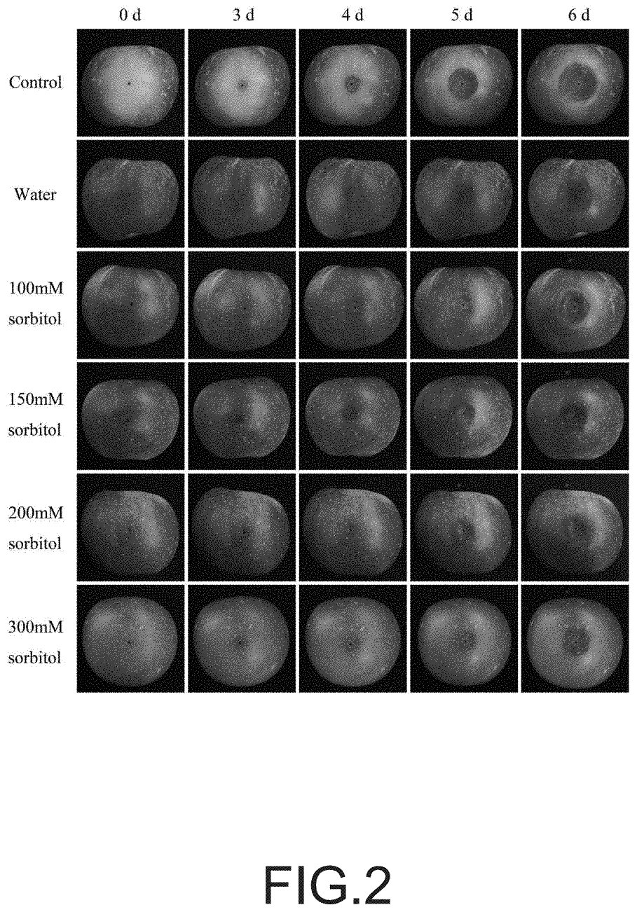

Within 3 d, 4 d, 5 d and 6 d after inoculation, the incidence conditions of ring rot of the “Fuji” fruits were shown as FIG. 2; and statistical results of the disease spot diameters were shown as FIG. 5B. With extension of the inoculation time, compared with the control, an increase rate of the disease spot diameters of the “Fuji” fruits treated with the sorbitol solution was significantly decreased; within 6 d after inoculation, the disease spot diameter of the “Fuji” fruits in the single pathogenic fungus inoculation treatment was 2.50 cm; with the increase of the concentration of the sorbitol solution, the disease spot diameter of the “Fuji” fruits was significantly decreased; the disease spot diameter of the fruits treated with the sorbitol solution of 150 mM was 1.86 cm, and had no significant difference from the disease spot diameter of the “Fuji” fruits treated with the sorbitol solutions of 200 mM and 300 mM. The above descriptions showed that the sorbitol treatment significantly inhibited the enlargement of the ring rot disease spots of the “Fuji” fruits; and an optimum treatment concentration was 150 mM.

### Embodiment 4

To verify whether external application of sorbitol can improve resistance of apple fruits to ring rot, an inoculation experiment of “Gala” apple fruits was provided in embodiment 4 of the present application.

S41: An in-vitro inoculation method was adopted for identifying disease resistance of the “Gala” apple fruits, and 6 treatments were set as follows:

Single pathogenic fungus inoculation treatment;

Pathogenic fungus inoculation treatment of soaking in deionized water:

Pathogenic fungus inoculation treatment of soaking in sorbitol solution of 100 mM:

Pathogenic fungus inoculation treatment of soaking in sorbitol solution of 150 mM;

Pathogenic fungus inoculation treatment of soaking in sorbitol solution of 200 mM;

Pathogenic fungus inoculation treatment of soaking in sorbitol solution of 300 mM.

S42: Surfaces of mature “Gala” fruits (within 120 days after flowering) were disinfected with 0.1% of sodium hypochlorite; and the fruits were fully washed with sterilized deionized water, aired and stood at 25° C. for 12 h for later use.

S43: The “Gala” fruits of the same size were selected and respectively soaked in the sterilized deionized water, the sorbitol solution of 100 mM, the sorbitol solution of 150 mM, the sorbitol solution of 200 mM and the sorbitol solution of 300 mM; and 10 fruits were treated in each treatment. The apples were taken out within 3 h after treatment; surface liquid was wiped up; middle parts of the surfaces of the apple fruits were punctured by sterilized toothpicks at a depth of 5 mm; 0.02 g of Botryosphaeria dothidea hyphae having vigorous and consistent growth within 10 days was added into the punctured parts; and the single pathogenic fungus inoculation treatment was taken as control. After inoculation, the “Gala” fruits were cultured in a thermostatic incubator at 28° C. in the dark. A disease spot diameter served as a measurement standard of the incidence degree of the apple fruits; diameters of 5 points of each disease spot were measured; and the mean value was taken as the result. Since 3 d after treatment, disease spot diameters of the apple fruits in different treatments were photographed and recorded every day; and the diameters were continuously recorded for 4 d. A significance level of disease spot size differences among the treatment groups was calculated according to analysis of variance.

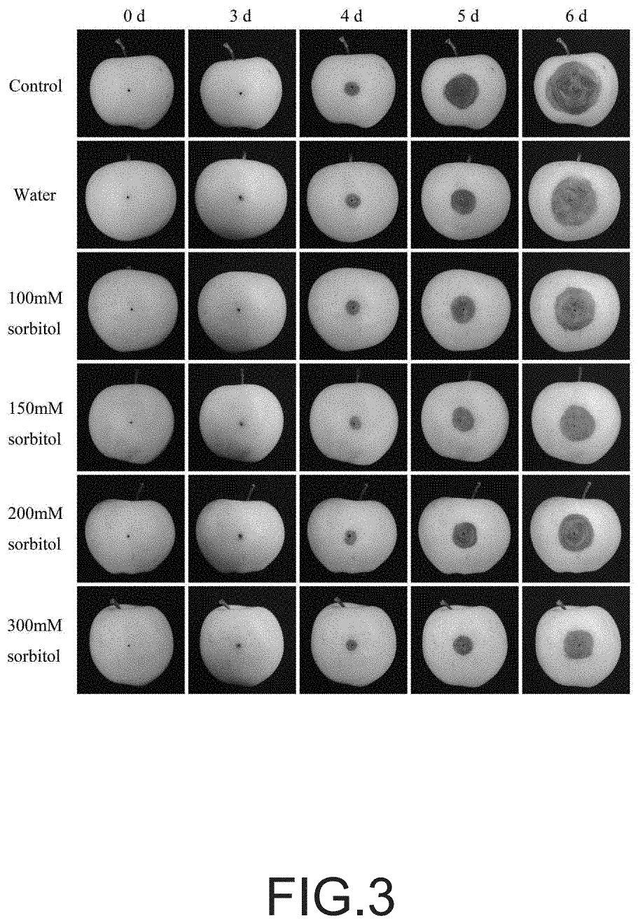

Within 3 d, 4 d. 5 d and 6 d after inoculation, the incidence conditions of ring rot of the “Gala” fruits were shown as FIG. 3; and statistical results of the disease spot diameters were shown as FIG. 5C. With extension of the inoculation time, compared with the control, an increase rate of the disease spot diameters of the “Gala” fruits treated with the sorbitol solution was significantly decreased; within 6 d after inoculation, the disease spot diameter of the “Gala” fruits in the single pathogenic fungus inoculation treatment was 2.48 cm; with the increase of the concentration of the sorbitol solution, the disease spot diameter of the “Gala” fruits was significantly decreased; the average disease spot diameter of the inoculated fruits treated with the sorbitol solution of 200 mM was 1.89 cm, and had no significant difference from the disease spot diameter of the “Gala” fruits treated with the sorbitol solutions of 300 mM. The above descriptions showed that the sorbitol treatment can significantly inhibit the incidence of the ring rot disease of the “Gala” fruits; and an optimum treatment concentration was 200 mM.

### Embodiment 5

To verify whether external application of sorbitol can improve resistance of apple fruits to ring rot, an inoculation experiment of “Golden delicious” apple fruits was provided in embodiment 5 of the present application.

S51: An in-vitro inoculation method was adopted for identifying disease resistance of the “Golden delicious” apple fruits; and 6 treatments were set as follows:

Single pathogenic fungus inoculation treatment;

Pathogenic fungus inoculation treatment of soaking in deionized water;

Pathogenic fungus inoculation treatment of soaking in sorbitol solution of 100 mM;

Pathogenic fungus inoculation treatment of soaking in sorbitol solution of 150 mM;

Pathogenic fungus inoculation treatment of soaking in sorbitol solution of 200 mM;

Pathogenic fungus inoculation treatment of soaking in sorbitol solution of 300 mM.

S52: Surfaces of mature “Golden delicious” fruits (within 135 days after flowering) were disinfected with 0.1% of sodium hypochlorite; and the fruits were fully washed with sterilized deionized water, aired and stood at 25° C. for 12 h for later use.

S53: The “Golden delicious” fruits of the same size were selected and respectively soaked in the sterilized deionized water, the sorbitol solution of 100 mM, the sorbitol solution of 150 mM, the sorbitol solution of 200 mM and the sorbitol solution of 300 mM; and 10 fruits were treated in each treatment. The apples were taken out within 3 h after treatment; surface liquid was wiped up; middle parts of the surfaces of the apple fruits were punctured by sterilized toothpicks at a depth of 5 mm; 0.02 g of Botryosphaeria dothidea hyphae having vigorous and consistent growth within 10 days was added into the punctured parts; and the single pathogenic fungus inoculation treatment was taken as control. After inoculation, the “Golden delicious” fruits were cultured in a thermostatic incubator at 28° C. in the dark. A disease spot diameter served as a measurement standard of the incidence degree of the apple fruits; diameters of 5 points of each disease spot were measured; and the mean value was taken as the result. Since 3 d after treatment, disease spot diameters of the apple fruits in different treatments were photographed and recorded every day; and the diameters were continuously recorded for 4 d. A significance level of disease spot size differences among the treatment groups was calculated according to analysis of variance.

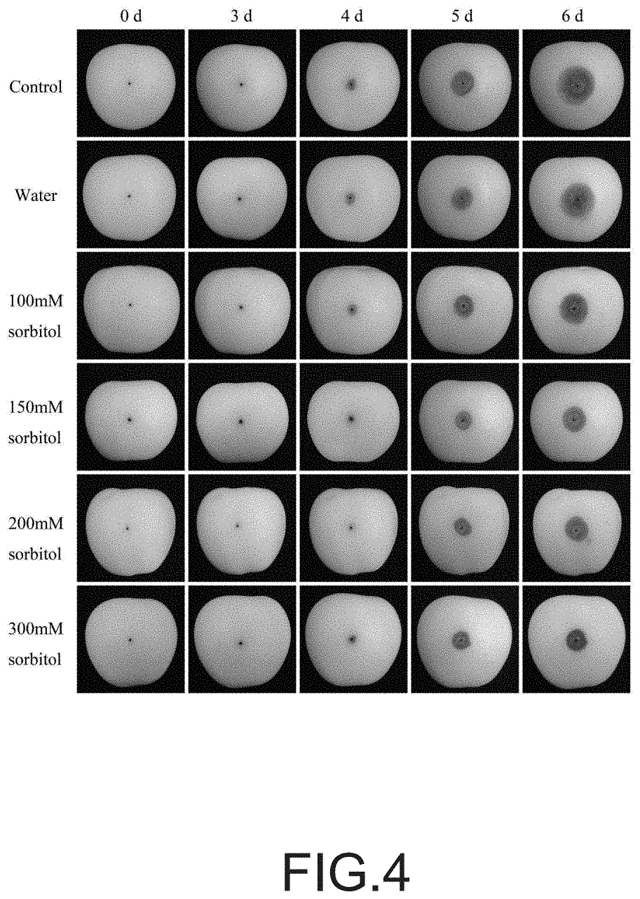

Within 3 d, 4 d, 5 d and 6 d after inoculation, the incidence conditions of ring rot of the “Golden delicious” fruits were shown as FIG. 4; and statistical results of the disease spot diameters were shown as FIG. 5D. With extension of the inoculation time, compared with the control, an increase rate of the disease spot diameters of the “Golden delicious” fruits treated with the sorbitol solution was significantly decreased; within 6 d after inoculation, the disease spot diameter of the “Golden delicious” fruits in the single pathogenic fungus inoculation treatment was 2.43 cm; with the increase of the concentration of the sorbitol solution, the disease spot diameter of the “Golden delicious” fruits was significantly decreased; the average disease spot diameter of the inoculated fruits treated with the sorbitol solution of 200 mM was 1.70 cm, and had no significant difference from the disease spot diameter of the “Golden delicious” fruits treated with the sorbitol solutions of 300 mM. The above descriptions showed that, the sorbitol treatment can significantly inhibit the incidence of the ring rot disease of the “Golden delicious” fruits; and an optimum treatment concentration was 200 mM.

The above results show that the exogenous sorbitol treatment in the present invention may significantly improve the resistance of the mature apple fruits to the ring rot. Moreover, the resistance of the apple fruits to the ring rot has sorbitol concentration dependence; and the research results have important significances for decreasing the ring rot of the apple fruits in the maturation period.

To sum up, the Bolryosphaeria B. dothidea inoculation test is conducted by utilizing the four apple varieties, such as the “Red delicious”. “Fuji”, “Gala” and “Golden delicious” in the present application. By integrating the detection results, economic cost and other factors, the resistance of the mature apple fruits to the ring rot may be significantly improved after treatment of the sorbitol solution of 200 mM; and identification results of different varieties are basically consistent. By utilizing the present research method, the barrier in control of the ring rot through chemical pesticides and the like may be overcome; and pollution of the pesticides and the like to the ecological environment is greatly decreased, thereby decreasing losses caused by occurrence of the apple ring rot in the maturation period or the storage period, and providing an efficient and environment-friendly method for controlling the ring rot and protecting the environment and human health.

Each embodiment in the description is described in a progressive way. The difference of each embodiment from each other is the focus of explanation. The same and similar parts among all of the embodiments can be referred to each other.

The above description of the disclosed embodiments enables those skilled in the art to realize or use the present invention. Many modifications to the embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A preparation for improving ring rot resistance of apple fruits, comprising sorbitol.

2. The preparation according to claim 1, wherein the apple fruits are mature apple fruits.

3. The preparation according to claim 1, wherein a concentration of the sorbitol is 100-300 mM.

4. The preparation according to claim 3, wherein the concentration of the sorbitol is 200 mM.

5. An application of the preparation of claim 1 in preparing a ring rot resistant preparation for apple fruits.

6. An application of the preparation of claim 1 in preparing a preparation for improving apple storage time.

7. An application of the preparation of claim 1 in preparing a preparation for improving apple food storage time.

8. The preparation according to claim 1, wherein the apples are one or more of varieties of “Red delicious”, “Fuji”, “Gala” and “Golden delicious”.

9. A method for improving ring rot resistance of mature apple fruits, wherein the apples are soaked with a sorbitol solution.

10. The method for improving ring rot resistance of mature apple fruits according to claim 9, wherein soaking time is 3 h.
